(19) United States
(12) Patent Application Publication
(10) Pub. No.: US 2026/0261829 A1
(43) Pub. Date: Sep. 3, 2026

(54) INFORMATION TRANSMISSION METHOD AND APPARATUS, AND STORAGE MEDIUM

(71) Applicant: Beijing Xiaomi Mobile Software Co., Ltd., Beijing (CN)

(72) Inventors: Wei HONG, Beijing (CN); Fang LI, Beijing (CN)

(73) Assignee: Beijing Xiaomi Mobile Software Co., Ltd., Beijing (CN)

(21) Appl. No.: 18/858,216

(22) PCT Filed: Apr. 19, 2022
(86) PCT No.: PCT/CN2022/087755

§ 371 Date: Oct. 18, 2024

(51) Int. Cl. H04W 4/40; H04W 4/024; H04W 76/20

(52) U.S. Cl. CPC H04W 4/40; H04W 4/024; H04W 76/20

(57) ABSTRACT

The present disclosure provides an information transmission method and apparatus, and a storage medium, where the information transmission method includes: reporting, to a base station, a total number of way points on a flight path of the unmanned aerial vehicle.

### CROSS-REFERENCE TO RELATED APPLICATION

The present application is a U.S. National Stage of International Application No. PCT/CN 2022/087755, filed on Apr. 19, 2022, the contents of which are incorporated herein by reference in their entirety.

### TECHNICAL FIELD

The present disclosure relates to the field of communications, and in particular, to an information transmission method and apparatus, and a storage medium.

### BACKGROUND

An unmanned aerial vehicle (UAV) is an unmanned aerial vehicle that is manipulated by using a radio remote control device and a self-contained program control apparatus. An unmanned aerial vehicle is actually a general term for unmanned aerial vehicles, and may be defined from a technical perspective as: an unmanned fixed-wing aircraft, an unmanned vertical take-off and landing aircraft, an unmanned airship, an unmanned helicopter, an unmanned multi-rotor aircraft, an unmanned umbrella wing aircraft, and the like.

With the rapid development of unmanned aerial vehicle technology, the reduction of cost and the improvement of function, unmanned aerial vehicles are increasingly applied to ordinary consumers. The applications of unmanned aerial vehicles to industry are the true need of unmanned aerial vehicles. At present, in the fields of aerial photography, agriculture, plant protection, miniature selfie, express transportation, disaster rescue, observation of wild animals, monitoring infectious diseases, surveying and mapping, news reporting, electric power inspection, disaster relief, film and television shooting, creating romance, and the like, the application of the unmanned aerial vehicle itself is greatly expanded, and all countries are actively expanding industry application and developing unmanned aerial vehicle technologies.

In order to further expand the application range of the unmanned aerial vehicle, the 3rd Generation Partnership Project (3GPP) approved the project of Enhanced Support for Aerial Vehicles. It is intended to study and standardize how to make cellular networks provide services that meet the needs of unmanned aerial vehicles.

Unmanned aerial vehicles typically have two flight modes. One is a fixed mode, that is, an operator plans a flight route of the unmanned aerial vehicle on a controller, so that the unmanned aerial vehicle can fly according to the planned route, and the controller does not need to control the unmanned aerial vehicle regularly. The other mode is a dynamic mode, that is, the controller may remotely control the unmanned aerial vehicle in real time through the controller. For the fixed mode, since the flight route and trajectory of the UAV are fixed, the cellular network may pre-judge which cellular network base stations the UAV will pass through.

### SUMMARY

In order to overcome the problems existing in the related art, embodiments of the present disclosure provide information transmission methods and apparatuses, and storage media.

According to a first aspect of an embodiment of present disclosure, an information transmission method is provided, which is performed by an unmanned aerial vehicle, and the method includes: reporting, to a base station, a total number of way points on a flight path of the unmanned aerial vehicle.

In some examples, the reporting, to a base station, a total number of way points on a flight path of the unmanned aerial vehicle includes: reporting the total number of way points to the base station through first radio resource control (RRC) signaling.

In some examples, the reporting the total number of way points to the base station through first radio resource control (RRC) signaling includes: reporting the total number of way points to the base station through a first information element in the first RRC signaling.

In some examples, the method further includes: reporting a notification message to the base station through the first RRC signaling, where the notification message notifies the base station that the unmanned aerial vehicle stores flight path information.

In some examples, the first RRC signaling includes any one of: RRC Reconfiguration Complete (RRCReconfigurationComplete) signaling; RRC Reestablishment Complete (RRCReestablishmentComplete) signaling; RRC Resume Complete (RRCResumeComplete) signaling; or RRC Setup Complete (RRCSetupComplete) signaling.

In some examples, the first RRC signaling includes any one of: RRC Connection Reconfiguration Complete (RRCConnectionReconfigurationComplete) signaling; RRC Connection Reestablishment Complete (RRCConnectionReestablishmentComplete) signaling; RRC Connection Resume Complete (RRCConnectionResumeComplete) signaling; or RRC Connection Setup Complete (RRCConnectionSetupComplete) signaling.

In some examples, the method further includes: receiving second RRC signaling sent by the base station, where the second RRC signaling configures a maximum number of way points allowed for the unmanned aerial vehicle to report.

In some examples, the maximum number of way points is carried in a second information element of the second RRC signaling.

In some examples, the second RRC signaling is user equipment information request (UEInformationRequest) signaling, and the second information element is a flight path information report configuration (FlightPathInfoReportConfig) information element.

In some examples, the method further includes: reporting, to the base station, flight path information corresponding to a first number of way points through third RRC signaling, where the first number of way points is a smaller one of the total number of way points and the maximum number of way points.

In some examples, the reporting flight path information corresponding to a first number of way points through third RRC signaling includes: reporting the flight path information corresponding to the first number of way points through a third information element in the third RRC signaling.

In some examples, the third RRC signaling is user equipment information response (UEInformationResponse) signaling, and the third information element is a flight path information report (FlightPathInfoReport) information element.

In some examples, the method further includes: when the total number of way points is greater than the maximum number of way points, receiving fourth RRC signaling sent by the base station, where the fourth RRC signaling instructs the unmanned aerial vehicle to continue to report flight path information; and reporting, based on a second number of way points carried in the fourth RRC signaling, flight path information corresponding to the second number of way points to the base station through new third RRC signaling, where the second number of way points is a difference between the total number of way points and the maximum number of way points.

In some examples, the second number of way points is carried in a fourth information element of the fourth RRC signaling.

In some examples, the fourth RRC signaling is user equipment information request (UEInformationRequest) signaling, and the fourth information element is a flight path information report configuration (FlightPathInfoReportConfig) information element.

According to a second aspect of an embodiment of present disclosure, an information transmission method is provided, which is performed by a base station, and the method includes: receiving a total number of way points on a flight path of an unmanned aerial vehicle reported by the unmanned aerial vehicle.

In some examples, the receiving a total number of way points on a flight path of an unmanned aerial vehicle reported by the unmanned aerial vehicle includes: receiving the total number of way points reported by the unmanned aerial vehicle through first radio resource control (RRC) signaling.

In some examples, the receiving the total number of way points reported by the unmanned aerial vehicle through first radio resource control (RRC) signaling includes: receiving the total number of way points reported by the unmanned aerial vehicle through a first information element in the first RRC signaling.

In some examples, the method further includes: receiving a notification message reported by the unmanned aerial vehicle through the first RRC signaling, where the notification message notifies the base station that the unmanned aerial vehicle stores flight path information.

In some examples, the first RRC signaling includes any one of: RRC Reconfiguration Complete (RRCReconfigurationComplete) signaling; RRC Reestablishment Complete (RRCReestablishmentComplete) signaling; RRC Resume Complete (RRCResumeComplete) signaling; or RRC Setup Complete (RRCSetupComplete) signaling.

In some examples, the first RRC signaling includes any one of: RRC Connection Reconfiguration Complete (RRCConnectionReconfigurationComplete) signaling; RRC Connection Reestablishment Complete (RRCConnectionReestablishmentComplete) signaling; RRC Connection Resume Complete (RRCConnectionResumeComplete) signaling; or RRC Connection Setup Complete (RRCConnectionSetupComplete) signaling.

In some examples, the method further includes: sending second RRC signaling to the unmanned aerial vehicle, where the second RRC signaling configures a maximum number of way points allowed for the unmanned aerial vehicle to report.

In some examples, the maximum number of way points is carried in a second information element of the second RRC signaling.

In some examples, the second RRC signaling is user equipment information request (UEInformationRequest) signaling, and the second information element is a flight path information report configuration (FlightPathInfoReportConfig) information element.

In some examples, the method further includes: receiving flight path information corresponding to a first number of way points reported by the unmanned aerial vehicle through third RRC signaling, where the first number of way points is a smaller one of the total number of way points and the maximum number of way points.

In some examples, the receiving flight path information corresponding to a first number of way points reported by the unmanned aerial vehicle through third RRC signaling includes: receiving the flight path information corresponding to the first number of way points reported by the unmanned aerial vehicle through a third information element in the third RRC signaling.

In some examples, the third RRC signaling is user equipment information response (UEInformationResponse) signaling, and the third information element is a flight path information report (FlightPathInfoReport) information element.

In some examples, the method further includes: when the total number of way points is greater than the maximum number of way points, sending fourth RRC signaling to the unmanned aerial vehicle, where the fourth RRC signaling instructs the unmanned aerial vehicle to continue to report flight path information; and receiving flight path information corresponding to a second number of way points reported by the unmanned aerial vehicle through new third RRC signaling, where the second number of way points is a difference between the total number of way points and the maximum number of way points.

In some examples, the method further includes: setting a specified value in a fourth information element of the fourth RRC signaling as the second number of way points.

In some examples, the fourth RRC signaling is user equipment information request (UEInformationRequest) signaling, and the fourth information element is a flight path information report configuration (FlightPathInfoReportConfig) information element.

According to a third aspect of an embodiment of present disclosure, an information transmission apparatus is provided, which is applied to an unmanned aerial vehicle, including: a reporting module, configured to report, to a base station, a total number of way points on a flight path of the unmanned aerial vehicle.

According to a fourth aspect of an embodiment of present disclosure, an information transmission apparatus is provided, which is applied to a base station, including: a receiving module, configured to receive a total number of way points on a flight path of an unmanned aerial vehicle reported by the unmanned aerial vehicle.

According to a fifth aspect of an embodiment of the present disclosure, a computer-readable storage medium is provided, where the storage medium stores a computer program for executing any one of the information transmission methods on the unmanned aerial vehicle side.

According to a sixth aspect of an embodiment of the present disclosure, a computer-readable storage medium is provided, where the storage medium stores a computer program for executing any one of the information transmission methods on the base station side.

According to a seventh aspect of an embodiment of the present disclosure, an information transmission apparatus is provided, including: a processor; and a memory, configured to store processor-executable instructions. Where the processor is configured to execute any of the information transmission methods described on the unmanned aerial vehicle side.

According to an eighth aspect of an embodiment of the present disclosure, an information transmission apparatus is provided, including: a processor; and a memory, configured to store processor-executable instructions. Where the processor is configured to execute any of the information transmission methods described on the base station side.

The technical solutions provided by the embodiments of the present disclosure can include the following beneficial effects. In the present disclosure, the UAV can directly report the total number of way points on the flight path of the UAV to the base station, which improves the efficiency of reporting the flight path information of the UAV, ensures that the base station can effectively obtain complete flight path information of the UAV, and is simple to realize and high in availability.

It should be understood that the general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a flowchart of an information transmission method according to an embodiment of the present disclosure.

FIG. 2 is a flowchart of another information transmission method according to an embodiment of the present disclosure.

FIG. 3 is a flowchart of another information transmission method according to an embodiment of the present disclosure.

FIG. 4 is a flowchart of another information transmission method according to an embodiment of the present disclosure.

FIG. 5 is a flowchart of another information transmission method according to an embodiment of the present disclosure.

FIG. 6 is a flowchart of another information transmission method according to an embodiment of the present disclosure.

FIG. 7 is a flowchart of another information transmission method according to an embodiment of the present disclosure.

FIG. 8 is a flowchart of another information transmission method according to an embodiment of the present disclosure.

FIG. 9 is a flowchart of another information transmission method according to an embodiment of the present disclosure.

FIG. 10 is a flowchart of another information transmission method according to an embodiment of the present disclosure.

FIG. 11 is a flowchart of another information transmission method according to an embodiment of the present disclosure.

FIG. 12 is a flowchart of another information transmission method according to an embodiment of the present disclosure.

FIG. 13 is a flowchart of another information transmission method according to an embodiment of the present disclosure.

FIG. 14 is a flowchart of another information transmission method according to an embodiment of the present disclosure.

FIG. 15 is a block diagram of an information transmission apparatus according to an embodiment of the present disclosure.

FIG. 16 is a block diagram of another information transmission apparatus according to an embodiment of the present disclosure.

FIG. 17 is a structural schematic diagram of an information transmission apparatus according to an embodiment of the present disclosure of the present disclosure.

FIG. 18 is a structural schematic diagram of another information transmission apparatus according to an embodiment of the present disclosure of the present disclosure.

### DETAILED DESCRIPTION

Reference will now be made in detail to embodiments, examples of which are illustrated in the accompanying drawings. When the following description refers to the accompanying drawings, unless otherwise indicated, the same numbers in different accompanying drawings indicate the same or similar elements. Implementations described in the following embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the claims are also intended to include majority forms, unless the context clearly indicates otherwise. It should also be understood that the term “and/or” as used herein refers to any or all of the possible combinations containing at least one of the listed items in association.

It should be understood that although terms first, second, third, etc. may be used to describe various information in the present disclosure, these information should not be limited to these terms. These terms are used only to distinguish the same type of information from one another. For example, without departing from the scope of the present disclosure, first information can also be called second information, and similarly, the second information can also be called the first information. Depending on the context, the word “if” as used herein can be interpreted as “at” or “when” or “in response to determining”.

Next, the information transmission method provided by the present disclosure will be introduced from an unmanned aerial vehicle side.

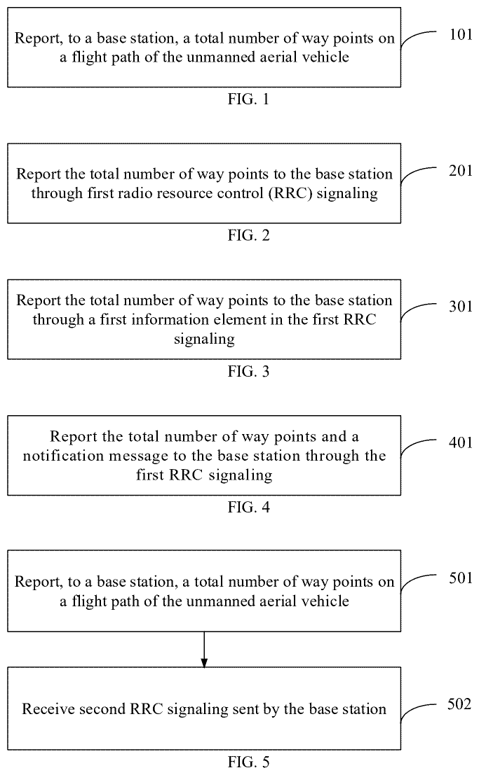

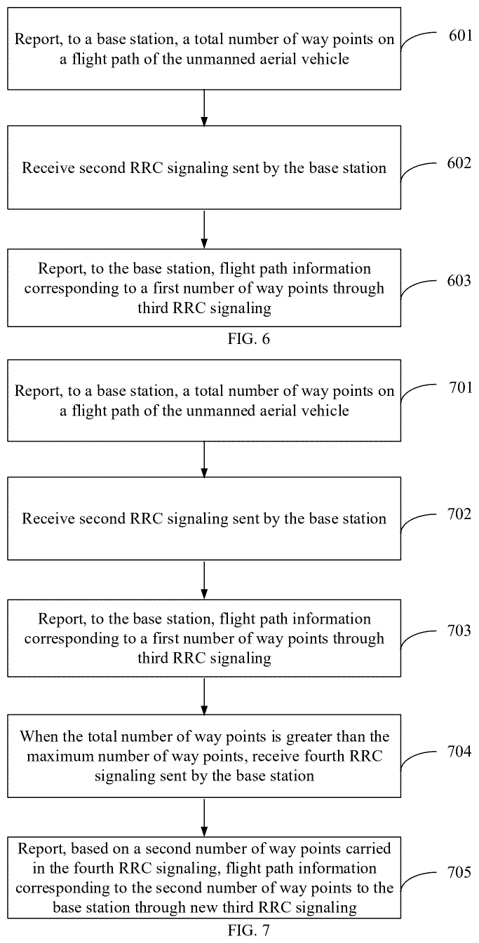

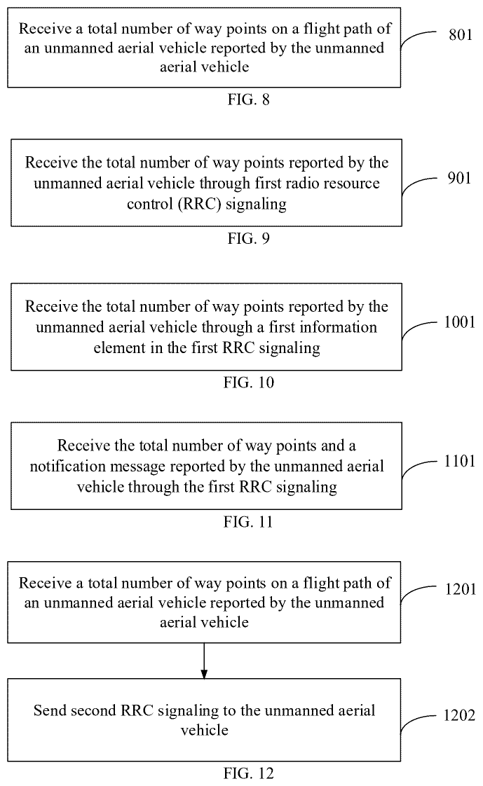

An embodiment of the present disclosure provides an information transmission method, referring to FIG. 1, FIG. 1 is a flowchart of an information transmission method according to an embodiment, which can be performed by an unmanned aerial vehicle, and the method may include step 101.

At step 101, a total number of way points on a flight path of the unmanned aerial vehicle is reported to a base station.

In the embodiment of the present disclosure, the flight path information of the unmanned aerial vehicle corresponds to at least one way point, i.e., in order to ensure that the unmanned aerial vehicle flies according to a specified route, at least one way point needs to be determined on the flight path, and the unmanned aerial vehicle must pass through this way point when flying.

It should be noted that when the unmanned aerial vehicle informs the base station of the total number of way points, the unmanned aerial vehicle uses an implicit way to inform the base station that the unmanned aerial vehicle stores the flight path information.

In the embodiment, the UAV can directly report the total number of way points on the flight path of the UAV to the base station, which improves the efficiency of reporting the flight path information of the UAV, ensures that the base station can effectively obtain complete flight path information of the UAV, and is simple to realize and high in availability.

In some embodiments, with reference to FIG. 2, FIG. 2 is a flowchart of an information transmission method according to an embodiment, which can be performed by an unmanned aerial vehicle, and the method may include step 201.

At step 201, the total number of way points is reported to the base station through first radio resource control (RRC) signaling.

The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol, in the case of a new Radio (NR) network, the first RRC signaling can be any of the following: RRC Reconfiguration Complete (RRCReconfigurationComplete) signaling; RRC Reestablishment Complete (RRCReestablishmentComplete) signaling; RRC Resume Complete (RRCResumeComplete) signaling; and RRC Setup Complete (RRCSetupComplete) signaling.

In another possible implementation, the first RRC signaling reuses the existing RRC signaling in the protocol, in the case of a long term evolution (LTE) network, the first RRC signaling can be any of the following: RRC Connection Reconfiguration Complete (RRCConnectionReconfigurationComplete) signaling; RRC Connection Reestablishment Complete (RRCConnectionReestablishmentComplete) signaling; RRC Connection Resume Complete (RRCConnectionResumeComplete) signaling; and RRC Connection Setup Complete (RRCConnectionSetupComplete) signaling.

It should be noted that when the unmanned aerial vehicle informs the base station of the total number of way points, the unmanned aerial vehicle uses an implicit way to inform the base station that the unmanned aerial vehicle stores the flight path information.

In the embodiment, the UAV can directly report the total number of way points on the flight path of the UAV to the base station through the first RRC signaling, which improves the efficiency of reporting the flight path information of the UAV, ensures that the base station can effectively obtain complete flight path information of the UAV, and is simple to realize and high in availability.

In some embodiments, with reference to FIG. 3, FIG. 3 is a flowchart of an information transmission method according to an embodiment, which can be performed by an unmanned aerial vehicle, and the method may include step 301.

At step 301, the total number of way points is reported to the base station through a first information element in the first RRC signaling.

The first RRC signaling can reuse existing RRC signaling in a protocol or use newly defined RRC signaling in the protocol. The first information element can reuse an existing information element in the existing RRC signaling, or the first information element is a newly defined information element in the existing RRC signaling or the newly defined RRC signaling, which is not limited by the present disclosure.

In a possible implementation, the first RRC signaling reuses the existing RRC signaling in the protocol, and in case of the NR network, the first RRC signaling can be any of the following: RRCReconfigurationComplete signaling; RRCReestablishmentComplete signaling; RRCResumeComplete signaling; and RRCSetupComplete signaling.

In another possible implementation, the first RRC signaling reuses the existing RRC signaling in the protocol, and in case of the LTE network, the first RRC signaling can be any of the following: RRCConnectionReconfigurationComplete signaling; RRCConnectionReestablishmentComplete signaling; RRCConnectionResumeComplete signaling; and RRCConnectionSetupComplete signaling.

It should be noted that when the unmanned aerial vehicle informs the base station of the total number of way points, the unmanned aerial vehicle uses an implicit way to inform the base station that the unmanned aerial vehicle stores the flight path information.

In the embodiment, the UAV can directly report the total number of way points on the flight path of the UAV to the base station through the first information element in the first RRC signaling, which improves the efficiency of reporting the flight path information of the UAV, ensures that the base station can effectively obtain complete flight path information of the UAV, and is simple to realize and high in availability.

In some embodiments, with reference to FIG. 4, FIG. 4 is a flowchart of an information transmission method according to an embodiment, which can be performed by an unmanned aerial vehicle, and the method may include step 401.

At step 401, the total number of way points and a notification message are reported to the base station through the first RRC signaling.

In the embodiment of the present disclosure, the notification message informs the base station that the unmanned aerial vehicle stores flight path information. That is, the unmanned aerial vehicle informs the base station in an explicit way that the flight path information is maintained on the unmanned aerial vehicle, and at the same time, the unmanned aerial vehicle informs the base station of the total number of way points.

The first RRC signaling can reuse existing RRC signaling in a protocol or use newly defined RRC signaling in the protocol. In some examples, the flight path information and the notification message may be carried by a newly defined information element in the first RRC signaling.

The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol, and in case of the NR network, the first RRC signaling can be any of the following: RRCReconfigurationComplete signaling; RRCReestablishmentComplete signaling; RRCResumeComplete signaling; and RRCSetupComplete signaling.

In another possible implementation, the first RRC signaling reuses the existing RRC signaling in the protocol, and in case of the LTE network, the first RRC signaling can be any of the following: RRCConnectionReconfigurationComplete signaling; RRCConnectionReestablishmentComplete signaling; RRCConnectionResumeComplete signaling; and RRCConnectionSetupComplete signaling.

In the embodiment, the UAV can directly report the total number of way points on the flight path of the UAV to the base station, and send a notification message to inform the base station that the UAV stores the flight path information, which improves the efficiency of reporting the flight path information of the UAV, ensures that the base station can effectively obtain complete flight path information of the UAV, and is simple to realize and high in availability.

In some embodiments, with reference to FIG. 5, FIG. 5 is a flowchart of an information transmission method according to an embodiment, which can be performed by an unmanned aerial vehicle, and the method may include steps 501 and 502.

At step 501, a total number of way points on a flight path of the unmanned aerial vehicle is reported to a base station.

The specific implementation can refer to the mode provided by FIGS. 1 to 3, and will not be described here.

At step 502, second RRC signaling sent by the base station is received.

In the embodiment of the present disclosure, the second RRC signaling configures a maximum number of way points allowed for the unmanned aerial vehicle to report. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and the second RRC signaling can be user equipment information request (UEInformationRequest) signaling.

In a possible implementation, the base station can configure the maximum number of way points according to at least one of base station memory, base station capability or the total number of way points reported by the unmanned aerial vehicle.

In the embodiment, after the UAV reports the total number of way points to the base station, the base station can configure the UAV with flight path information reporting, specifically, it can configure the UAV with the maximum number of way points that the UAV is allowed to report, which improves the efficiency of reporting the flight path information of the UAV, ensures that the base station can effectively obtain complete flight path information of the UAV, and is simple to realize and high in availability.

In some embodiments, the maximum number of way points is carried in a second information element of the second RRC signaling.

The second RRC signaling can reuse existing RRC signaling in a protocol or use newly defined RRC signaling in the protocol, and the second information element can reuse an existing information element in the existing RRC signaling, or the second information element is a newly defined information element in the existing RRC signaling or the newly defined RRC signaling, which is not limited by the present disclosure.

In a possible implementation, the second RRC signaling reuses the existing RRC signaling in the protocol, and the second information element reuses the existing information element in the existing RRC signaling, the second RRC signaling can be UEInformationRequest signaling, and the second information element can be a flight path information report configuration (FlightPathInfoReportConfig) information element in the UEInformationRequest signaling.

In some embodiments, with reference to FIG. 6, FIG. 6 is a flowchart of an information transmission method according to an embodiment, which can be performed by an unmanned aerial vehicle, and the method may include steps 601-603.

At step 601, a total number of way points on a flight path of the unmanned aerial vehicle is reported to a base station.

The specific implementation can refer to the mode provided by FIGS. 1 to 3, and will not be described here.

At step 602, second RRC signaling sent by the base station is received.

In the embodiment of the present disclosure, the second RRC signaling configures a maximum number of way points allowed for the unmanned aerial vehicle to report. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and the second RRC signaling can be UEInformationRequest signaling.

In a possible implementation, the base station can configure the maximum number of way points according to at least one of base station memory, base station capability or the total number of way points reported by the unmanned aerial vehicle.

At step 603, flight path information corresponding to a first number of way points is reported to the base station through third RRC signaling.

In the embodiment of the present disclosure, the third RRC signaling can reuse existing RRC signaling in a protocol or use newly defined RRC signaling in the protocol. The first number of way points is a smaller one of the total number of way points and the maximum number of way points. That is, when the total number of way points is less than or equal to the maximum number of way points that can be reported by the unmanned aerial vehicle, the unmanned aerial vehicle can report flight path information corresponding to the total number of way points to the base station. Alternatively, when the total number of way points is greater than the maximum number of way points that can be reported by the unmanned aerial vehicle, the unmanned aerial vehicle can report flight path information corresponding to the maximum number of way points that can be reported by the unmanned aerial vehicle to the base station. And at this time, there is still flight path information corresponding to a part of number of way points that have not been reported to the base station, and the flight path information corresponding to the remaining number of way points can be reported in the subsequent process.

In a possible implementation, the third RRC signaling can reuse the existing RRC signaling in the protocol, and the third RRC signaling can be user equipment information response (UEInformationResponse) signaling.

In the embodiment, the UAV can report the flight path information based on the configuration of the base station side, which improves the efficiency of reporting the flight path information of the UAV, ensures that the base station can effectively obtain complete flight path information of the UAV, and is simple to realize and high in availability.

In some embodiments, the unmanned aerial vehicle can report the flight path information corresponding to the first number of way points through a third information element in the third RRC signaling.

In the embodiment of the present disclosure, the third RRC signaling can reuse existing RRC signaling in a protocol or use newly defined RRC signaling in the protocol. The third information element can reuse an existing information element in the existing RRC signaling, or the third information element is a newly defined information element in the existing RRC signaling or the newly defined RRC signaling, which is not limited by the present disclosure.

In a possible implementation, the third RRC signaling reuses the existing RRC signaling in the protocol, and the third information element reuses the existing information element in the existing RRC signaling, the third RRC signaling can be UEInformationResponse signaling, and the third information element can be a flight path information report (FlightPathInfoReport) information element in the UEInformationResponse signaling.

In some embodiments, with reference to FIG. 7, FIG. 7 is a flowchart of an information transmission method according to an embodiment, which can be performed by an unmanned aerial vehicle, and the method may include steps 701-705.

At step 701, a total number of way points on a flight path of the unmanned aerial vehicle is reported to a base station.

The specific implementation can refer to the mode provided by FIGS. 1 to 3, and will not be described here.

At step 702, second RRC signaling sent by the base station is received.

In the embodiment of the present disclosure, the second RRC signaling configures a maximum number of way points allowed for the unmanned aerial vehicle to report. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and the second RRC signaling can be user equipment information request (UEInformationRequest) signaling.

In a possible implementation, the base station can configure the maximum number of way points according to at least one of base station memory, base station capability or the total number of way points reported by the unmanned aerial vehicle. The base station can also configure the maximum number of way points by simultaneously considering a reporting capability of the unmanned aerial vehicle.

At step 703, flight path information corresponding to a first number of way points is reported to the base station through third RRC signaling.

In the embodiment of the present disclosure, the third RRC signaling can reuse existing RRC signaling in a protocol or use newly defined RRC signaling in the protocol. The first number of way points is a smaller one of the total number of way points and the maximum number of way points.

In a possible implementation, the third RRC signaling can reuse the existing RRC signaling in the protocol, and the third RRC signaling can be UEInformationResponse signaling.

At step 704, when the total number of way points is greater than the maximum number of way points, fourth RRC signaling sent by the base station is received.

In the embodiment of the present disclosure, the fourth RRC signaling instructs the unmanned aerial vehicle to continue to report flight path information. The fourth RRC signaling can reuse existing RRC signaling in a protocol or use newly defined RRC signaling in the protocol.

In a possible implementation, the fourth RRC signaling reuses the existing RRC signaling in the protocol, and the fourth RRC be UEInformationRequest signaling.

At step 705, based on a second number of way points carried in the fourth RRC signaling, flight path information corresponding to the second number of way points is reported to the base station through new third RRC signaling.

In the embodiment of the present disclosure, the second number of way points is a difference between the total number of way points and the maximum number of way points. The unmanned aerial vehicle can report the flight path information corresponding to the second number of way points through the new third RRC signaling. That is, after receiving the flight path information sent by the unmanned aerial vehicle according to its configured maximum number of way points, the base station determines remaining number of way points of the unmanned aerial vehicle (i.e., the second number of way points), and continues to send RRC signaling (the fourth RRC signaling) to the unmanned aerial vehicle to configure the unmanned aerial vehicle to send the flight path information corresponding to the remaining number of way points to the base station through RRC signaling (the new third RRC signaling).

In a possible implementation, the new third RRC signaling can reuse existing RRC signaling in the protocol, and the new third RRC signaling can be UEInformationResponse signaling. In the embodiment, the efficiency of reporting the flight path information of the unmanned aerial vehicle is improved, and the base station can effectively obtain complete flight path information of the unmanned aerial vehicle, which is simple and convenient to realize and has high availability.

In some embodiments, the base station carries the second number of way points through the fourth information element of the fourth RRC signaling. The fourth RRC signaling instructs the unmanned aerial vehicle to continue to report flight path information. The fourth RRC signaling can reuse existing RRC signaling in a protocol or use newly defined RRC signaling in the protocol. The fourth information element can reuse an existing information element in the existing RRC signaling, or the fourth information element is a newly defined information element in the existing RRC signaling or the newly defined RRC signaling, which is not limited by the present disclosure.

In a possible implementation, the fourth RRC signaling is UEInformationRequest signaling, and the fourth information element is a flight path information report configuration (FlightPathInfoReportConfig) information element in the UEInformationRequest signaling.

Next, the information transmission method provided by the present disclosure will be introduced from a base station side.

An embodiment of the present disclosure provides an information transmission method, referring to FIG. 8, FIG. 8 is a flowchart of an information transmission method according to an embodiment, which can be performed by a base station, and the method may include step 801.

At step 801, a total number of way points on a flight path of an unmanned aerial vehicle reported by the unmanned aerial vehicle is received.

In the embodiment of the present disclosure, the flight path information of the unmanned aerial vehicle corresponds to at least one way point, i.e., in order to ensure that the unmanned aerial vehicle flies according to a specified route, at least one way point needs to be determined on the flight path, and the unmanned aerial vehicle must pass through this way point when flying.

In the embodiment of the present disclosure, the unmanned aerial vehicle directly reports the total number of way points on the flight path to the base station. It should be noted that when receiving the total number of way points reported by the unmanned aerial vehicle, the base station determines that the unmanned aerial vehicle stores flight path information. That is, the unmanned aerial vehicle informs the base station that it stores the flight path information in an implicit way. When the base station receives the total number of way points reported by the unmanned aerial vehicle, it can confirm that the unmanned aerial vehicle has the flight path information, without the unmanned aerial vehicle informing the base station that it has the flight path information through additional signaling.

In the embodiment, the base station can receive the total number of way points directly reported by the UAV, which improves the efficiency of reporting the flight path information of the UAV, ensures that the base station can effectively obtain complete flight path information of the UAV, and is simple to realize and high in availability.

In some embodiments, with reference to FIG. 9, FIG. 9 is a flowchart of an information transmission method according to an embodiment, which can be performed by a base station, and the method may include step 901.

At step 901, the total number of way points reported by the unmanned aerial vehicle through first radio resource control (RRC) signaling is received.

In the embodiment of the present disclosure, the first RRC signaling can reuse existing RRC signaling in a protocol or use newly defined RRC signaling in the protocol.

In a possible implementation, the first RRC signaling reuses the existing RRC signaling in the protocol, and in case of the NR network, the first RRC signaling can be any of the following: RRCReconfigurationComplete signaling; RRCReestablishmentComplete signaling; RRCResumeComplete signaling; and RRCSetupComplete signaling.

In another possible implementation, the first RRC signaling reuses the existing RRC signaling in the protocol, and in case of the LTE network, the first RRC signaling can be any of the following: RRCConnectionReconfigurationComplete signaling; RRCConnectionReestablishmentComplete signaling; RRCConnectionResumeComplete signaling; and RRCConnectionSetupComplete signaling.

It should be noted that when receiving the total number of way points reported by the unmanned aerial vehicle, the base station determines that the unmanned aerial vehicle stores flight path information. That is, the unmanned aerial vehicle informs the base station that it stores the flight path information in an implicit way. When the base station receives the total number of way points reported by the unmanned aerial vehicle, it can confirm that the unmanned aerial vehicle has the flight path information, without the unmanned aerial vehicle informing the base station that it has the flight path information through additional signaling. In the embodiment, the base station can receive the total number of way points reported by the UAV through the first RRC signaling, which improves the efficiency of reporting the flight path information of the UAV, ensures that the base station can effectively obtain complete flight path information of the UAV, and is simple to realize and high in availability.

In some embodiments, with reference to FIG. 10, FIG. 10 is a flowchart of an information transmission method according to an embodiment, which can be performed by a base station, and the method may include step 1001.

At step 1001, the total number of way points reported by the unmanned aerial vehicle through a first information element in the first RRC signaling is received.

The first RRC signaling can reuse existing RRC signaling in a protocol or use newly defined RRC signaling in the protocol. The first information element can reuse an existing information element in the existing RRC signaling, or the first information element is a newly defined information element in the existing RRC signaling or the newly defined RRC signaling, which is not limited by the present disclosure.

In a possible implementation, the first RRC signaling reuses the existing RRC signaling in the protocol, and in case of the NR network, the first RRC signaling can be any of the following: RRCReconfigurationComplete signaling; RRCReestablishmentComplete signaling; RRCResumeComplete signaling; and RRCSetupComplete signaling.

In another possible implementation, the first RRC signaling reuses the existing RRC signaling in the protocol, and in case of the LTE network, the first RRC signaling can be any of the following: RRCConnectionReconfigurationComplete signaling; RRCConnectionReestablishmentComplete signaling; RRCConnectionResumeComplete signaling; and RRCConnectionSetupComplete signaling.

It should be noted that when receiving the total number of way points reported by the unmanned aerial vehicle, the base station determines that the unmanned aerial vehicle stores flight path information. That is, the unmanned aerial vehicle informs the base station that it stores the flight path information in an implicit way. When the base station receives the total number of way points reported by the unmanned aerial vehicle, it can confirm that the unmanned aerial vehicle has the flight path information, without the unmanned aerial vehicle informing the base station that it has the flight path information through additional signaling.

In the embodiment, the base station can receive the total number of way points reported by the unmanned aerial vehicle through the first information element in the first RRC signaling, which improves the efficiency of reporting the flight path information of the UAV, ensures that the base station can effectively obtain complete flight path information of the UAV, and is simple to realize and high in availability.

In some embodiments, with reference to FIG. 11, FIG. 11 is a flowchart of an information transmission method according to an embodiment, which can be performed by a base station, and the method may include step 1101.

At step 1101, the total number of way points and a notification message reported by the unmanned aerial vehicle through the first RRC signaling are received.

The notification message informs the base station that the unmanned aerial vehicle stores flight path information.

The first RRC signaling can reuse existing RRC signaling in a protocol or use newly defined RRC signaling in the protocol. In some examples, the flight path information and the notification message may be carried by a newly defined information element in the first RRC signaling.

The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol, and in case of the NR network, the first RRC signaling can be any of the following: RRCReconfigurationComplete signaling; RRCReestablishmentComplete signaling; RRCResumeComplete signaling; and RRCSetupComplete signaling.

In another possible implementation, the first RRC signaling reuses the existing RRC signaling in the protocol, and in case of the LTE network, the first RRC signaling can be any of the following: RRCConnectionReconfigurationComplete signaling; RRCConnectionReestablishmentComplete signaling; RRCConnectionResumeComplete signaling; and RRCConnectionSetupComplete signaling.

In the embodiment, the UAV can send the notification message and the total number of way points together to the base station, which improves the efficiency of reporting the flight path information of the UAV, ensures that the base station can effectively obtain complete flight path information of the UAV, and is simple to realize and high in availability.

In some embodiments, with reference to FIG. 12, FIG. 12 is a flowchart of an information transmission method according to an embodiment, which can be performed by a base station, and the method may include steps 1201 and 1202.

At step 1201, a total number of way points on a flight path of an unmanned aerial vehicle reported by the unmanned aerial vehicle is received.

At step 1202, second RRC signaling is sent to the unmanned aerial vehicle.

In the embodiment of the present disclosure, the second RRC signaling configures a maximum number of way points allowed for the unmanned aerial vehicle to report.

In a possible implementation, the second RRC signaling reuses the existing RRC signaling in the protocol, and the second RRC signaling can be UEInformationRequest signaling.

In a possible implementation, the base station can configure the maximum number of way points according to at least one of base station memory, base station capability or the total number of way points reported by the unmanned aerial vehicle.

In the embodiment, the base station can configure the maximum number of way points for the UAV, which improves the efficiency of reporting the flight path information of the UAV, ensures that the base station can effectively obtain complete flight path information of the UAV, and is simple to realize and high in availability.

In some embodiments, the maximum number of way points is carried in a second information element of the second RRC signaling.

The second RRC signaling can reuse existing RRC signaling in a protocol or use newly defined RRC signaling in the protocol, and the second information element can reuse an existing information element in the existing RRC signaling, or the second information element is a newly defined information element in the existing RRC signaling or the newly defined RRC signaling, which is not limited by the present disclosure.

In a possible implementation, the second RRC signaling reuses the existing RRC signaling in the protocol, and the second information element reuses the existing information element in the existing RRC signaling, the second RRC signaling can be UEInformationRequest signaling, and the second information element can be a flight path information report configuration (FlightPathInfoReportConfig) information element in the UEInformationRequest signaling.

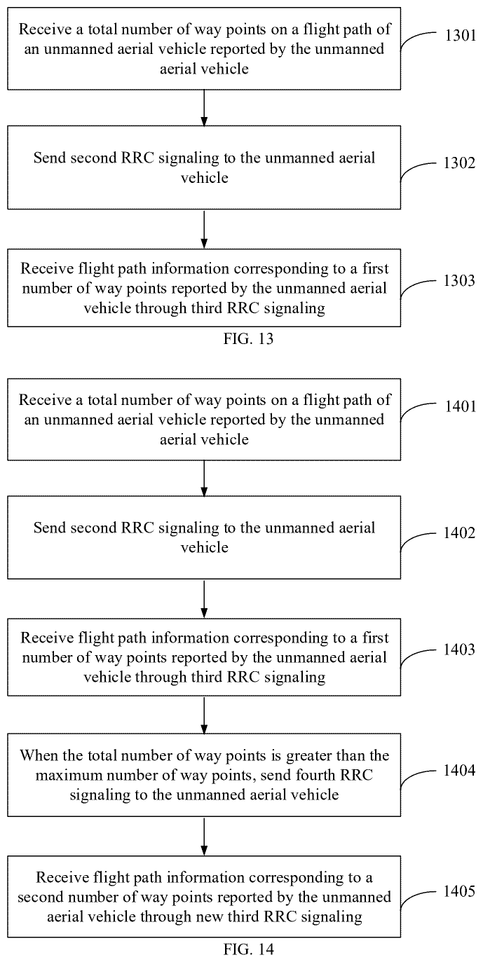

In some embodiments, with reference to FIG. 13, FIG. 13 is a flowchart of an information transmission method according to an embodiment, which can be performed by a base station, and the method may include steps 1301-1303.

At step 1301, a total number of way points on a flight path of an unmanned aerial vehicle reported by the unmanned aerial vehicle is received.

At step 1302, second RRC signaling is sent to the unmanned aerial vehicle.

In the embodiment of the present disclosure, the second RRC signaling configures a maximum number of way points allowed for the unmanned aerial vehicle to report.

In a possible implementation, the second RRC signaling reuses the existing RRC signaling in the protocol, and the second RRC signaling can be UEInformationRequest signaling.

In a possible implementation, the base station can configure the maximum number of way points according to at least one of base station memory, base station capability or the total number of way points reported by the unmanned aerial vehicle.

At step 1303, flight path information corresponding to a first number of way points reported by unmanned aerial vehicle through third RRC signaling is received.

In the embodiment of the present disclosure, the third RRC signaling can reuse existing RRC signaling in a protocol or use newly defined RRC signaling in the protocol. The first number of way points is a smaller one of the total number of way points and the maximum number of way points. That is, when the total number of way points is less than or equal to the maximum number of way points that can be reported by the unmanned aerial vehicle, the base station can receive the flight path information corresponding to the total number of way points reported by the unmanned aerial vehicle. Alternatively, when the total number of way points is greater than the maximum number of way points that can be reported by the unmanned aerial vehicle, the unmanned aerial vehicle can report the flight path information corresponding to the maximum number of way points that can be reported by the unmanned aerial vehicle to the base station, i.e., the base station only receives flight path information corresponding to a part of the number of way points, and at this time, there are still flight path information corresponding to a part of number of way points that have not been reported by the unmanned aerial vehicle to the base station, and the flight path information corresponding to the remaining number of way points can be reported by the unmanned aerial vehicle and received by the base station in the subsequent process.

In a possible implementation, the third RRC signaling can reuse the existing RRC signaling in the protocol, and the third RRC signaling can be UEInformationResponse signaling.

In some embodiments, the unmanned aerial vehicle can report the flight path information corresponding to the first number of way points through a third information element in the third RRC signaling.

In the embodiment of the present disclosure, the third RRC signaling can reuse existing RRC signaling in a protocol or use newly defined RRC signaling in the protocol. The third information element can reuse an existing information element in the existing RRC signaling, or the third information element is a newly defined information element in the existing RRC signaling or the newly defined RRC signaling, which is not limited by the present disclosure.

In a possible implementation, the third RRC signaling reuses the existing RRC signaling in the protocol, and the third information element reuses the existing information element in the existing RRC signaling, the third RRC signaling can be UEInformationResponse signaling, and the third information element can be a flight path information report (FlightPathInfoReport) information element in the UEInformationResponse signaling.

In the embodiment, the base station can receive the flight path information reported by the UAV based on the configuration of the base station, which improves the efficiency of reporting the flight path information of the UAV, ensures that the base station can effectively obtain complete flight path information of the UAV, and is simple to realize and high in availability.

In some embodiments, with reference to FIG. 14, FIG. 14 is a flowchart of an information transmission method according to an embodiment, which can be performed by a base station, and the method may include steps 1401-1405.

At step 1401, a total number of way points on a flight path of an unmanned aerial vehicle reported by the unmanned aerial vehicle is received.

At step 1402, second RRC signaling is sent to the unmanned aerial vehicle.

In the embodiment of the present disclosure, the second RRC signaling configures a maximum number of way points allowed for the unmanned aerial vehicle to report.

In a possible implementation, the second RRC signaling reuses the existing RRC signaling in the protocol, and the second RRC signaling can be UEInformationRequest signaling.

In a possible implementation, the base station can configure the maximum number of way points according to at least one of base station memory, base station capability or the total number of way points reported by the unmanned aerial vehicle. The base station may also take into account a reporting capability of the unmanned aerial vehicle when configuring the maximum number of way points, and the present disclosure does not limit this.

At step 1403, flight path information corresponding to a first number of way points reported by unmanned aerial vehicle through third RRC signaling is received.

In the embodiment of the present disclosure, the third RRC signaling can reuse existing RRC signaling in a protocol or use newly defined RRC signaling in the protocol. The first number of way points is a smaller one of the total number of way points and the maximum number of way points.

In a possible implementation, the third RRC signaling can reuse the existing RRC signaling in the protocol, and the third RRC signaling can be UEInformationResponse signaling.

At step 1404, when the total number of way points is greater than the maximum number of way points, fourth RRC signaling is sent to the unmanned aerial vehicle.

In the embodiment of the present disclosure, the fourth RRC signaling instructs the unmanned aerial vehicle to continue to report flight path information. The fourth RRC signaling can reuse existing RRC signaling in a protocol or use newly defined RRC signaling in the protocol.

In a possible implementation, the fourth RRC signaling reuses the existing RRC signaling in the protocol, and the fourth RRC be UEInformationRequest signaling.

At step 1405, flight path information corresponding to a second number of way points reported by the unmanned aerial vehicle through new third RRC signaling is received.

The second number of way points is a difference between the total number of way points and the maximum number of way points. The unmanned aerial vehicle can report the flight path information corresponding to the second number of way points through the new third RRC signaling.

That is, after receiving the flight path information sent by the unmanned aerial vehicle according to its configured maximum number of way points, the base station determines remaining number of way points of the unmanned aerial vehicle (i.e., the second number of way points), and continues to send RRC signaling (the fourth RRC signaling) to the unmanned aerial vehicle to configure the unmanned aerial vehicle to send the flight path information corresponding to the remaining number of way points to the base station through RRC signaling (the new third RRC signaling).

In a possible implementation, the new third RRC signaling can reuse existing RRC signaling in the protocol, and the new third RRC signaling can be UEInformationResponse signaling.

In the embodiment, the efficiency of reporting the flight path information of the unmanned aerial vehicle is improved, and the base station can effectively obtain complete flight path information of the unmanned aerial vehicle, which is simple and convenient to realize and has high availability.

In some embodiments, the base station may set a specified value in a fourth information element of the fourth RRC signaling as the second number of way points.

The specified value can be a value corresponding to a parameter maximum number of way points (max WayPointNumber).

The fourth RRC signaling instructs the unmanned aerial vehicle to continue to report flight path information. The fourth RRC signaling can reuse existing RRC signaling in a protocol or use newly defined RRC signaling in the protocol. The fourth information element can reuse an existing information element in the existing RRC signaling, or the fourth information element is a newly defined information element in the existing RRC signaling or the newly defined RRC signaling, which is not limited by the present disclosure.

In a possible implementation, the fourth RRC signaling is UEInformationRequest signaling, and the fourth information element is a flight path information report configuration (FlightPathInfoReportConfig) information element in the UEInformationRequest signaling.

Corresponding to the foregoing embodiments of the application function realization methods, the present disclosure further provides embodiments of application function realization apparatuses.

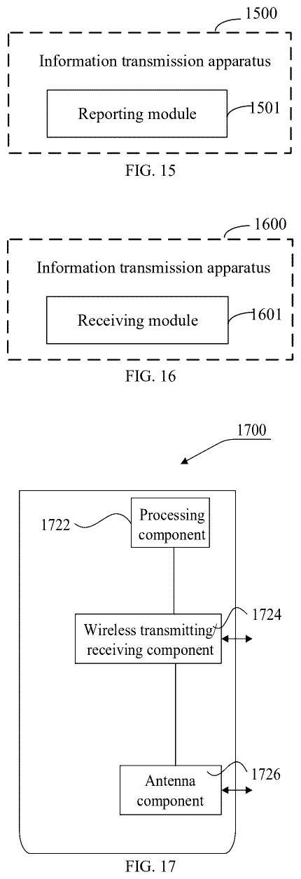

Referring to FIG. 15, FIG. 15 is a block diagram of an information transmission apparatus 1500 according to an embodiment of the present disclosure, which is applied to an unmanned aerial vehicle and includes a reporting module 1501.

The reporting module 1501 is configured to report, to a base station, a total number of way points on a flight path of the unmanned aerial vehicle.

Referring to FIG. 16, FIG. 16 is a block diagram of an information transmission apparatus 1600 according to an embodiment of the present disclosure, which is applied to a base station and includes a receiving module 1601.

The receiving module 1601 is configured to receive a total number of way points on a flight path of an unmanned aerial vehicle reported by the unmanned aerial vehicle.

For the apparatus embodiment, because it basically corresponds to the method embodiments, it is only necessary to refer to the method embodiments for the relevant part of the description. The apparatus embodiments described are only schematic, in which the units/modules described as separate components may or may not be physically separated, and the components displayed as units/modules may or may not be physical units/modules, that is, they may be located in one place or distributed to multiple network units/modules. Some or all of the modules can be selected according to actual needs to achieve the purpose of the solution of the present disclosure. It can be understood and implemented by a person of ordinary skill in the art without creative labor.

Correspondingly, the present disclosure further provides a non-transitory computer-readable storage medium, where the storage medium stores a computer program for executing any of the information transmission methods described for the unmanned aerial vehicle side.

Correspondingly, the present disclosure further provides a non-transitory computer-readable storage medium, where the storage medium stores a computer program for executing any of the information transmission methods described for the base station side.

Correspondingly, the present disclosure further provides an information transmission apparatus, including: a processor; and a memory, configured to store processor-executable instructions; where the processor is configured to execute any of the information transmission methods described on the unmanned aerial vehicle side.

As shown in FIG. 17, FIG. 17 is a schematic structural diagram of an information transmission apparatus 1700 according to an embodiment of the present disclosure. The apparatus 1700 may be provided as an unmanned aerial vehicle. Referring to FIG. 17, the apparatus 1700 includes a processing component 1722, a wireless transmitting/receiving component 1724, an antenna component 1726, and a signal processing part (not shown) unique to a wireless interface, and the processing component 1722 may further include at least one processor (not shown).

One of the processors (not shown) in the processing component 1722 may be configured to perform any of the information transmission methods described for the unmanned aerial vehicle side.

Correspondingly, the present disclosure further provides an information transmission apparatus, including: a processor; and a memory, configured to store processor-executable instructions; where the processor is configured to execute any of the information transmission methods described on the base station side.

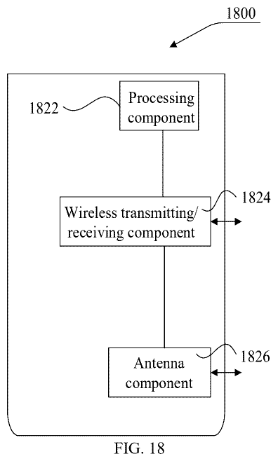

As shown in FIG. 18, FIG. 18 is a schematic structural diagram of an information transmission apparatus 1800 according to an embodiment of the present disclosure. The apparatus 1800 may be provided as a base station. Referring to FIG. 18, the apparatus 1800 includes a processing component 1822, a wireless transmitting/receiving component 1824, an antenna component 1826, and a signal processing part (not shown) unique to a wireless interface, and the processing component 1822 may further include at least one processor (not shown).

One of the processors (not shown) in the processing component 1822 may be configured to perform any of the information transmission methods described for the base station side.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described and shown in the accompanying drawings, and various modifications and changes can be made without departing from its scope. The scope of the present disclosure is limited only by the appended claims.

1. An information transmission method, performed by an unmanned aerial vehicle, comprising:
reporting, to a base station, a total number of way points on a flight path of the unmanned aerial vehicle.

2. The method according to claim 1, wherein reporting, to the base station, the total number of way points on the flight path of the unmanned aerial vehicle comprises:
reporting the total number of way points to the base station through first radio resource control (RRC) signaling.

3. (canceled)

4. The method according to claim 2, wherein
the first RRC signaling is further used to report a notification message to the base station, and
the notification message notifies the base station that the unmanned aerial vehicle stores flight path information.

5. The method according to claim 2, wherein the first RRC signaling comprises any one of:
RRC Reconfiguration Complete (RRCReconfigurationComplete) signaling;
RRC Reestablishment Complete (RRCReestablishmentComplete) signaling;
RRC Resume Complete (RRCResumeComplete) signaling;
RRC Setup Complete (RRCSetupComplete) signaling;
RRC Connection Reconfiguration Complete (RRCConnectionReconfigurationComplete) signaling;
RRC Connection Reestablishment Complete (RRCConnectionReestablishmentComplete) signaling;
RRC Connection Resume Complete (RRCConnectionResumeComplete) signaling; or
RRC Connection Setup Complete (RRCConnectionSetupComplete) signaling.

6. (canceled)

7. The method according to claim 1, further comprising:
receiving second RRC signaling sent by the base station, wherein the second RRC signaling configures a maximum number of way points for the unmanned aerial vehicle to report.

8. The method according to claim 7, wherein the maximum number of way points is carried in a second information element of the second RRC signaling.

9. The method according to claim 8, wherein the second RRC signaling is user equipment information request (UEInformationRequest) signaling, and the second information element is a flight path information report configuration (FlightPathInfoReportConfig) information element.

10. The method according to claim 7, further comprising:
reporting, to the base station, flight path information corresponding to a first number of way points through third RRC signaling, wherein the first number of way points is a smaller one of the total number of way points and the maximum number of way points.

11. The method according 10, wherein reporting the flight path information corresponding to the first number of way points through third RRC signaling comprises:
reporting the flight path information corresponding to the first number of way points through a third information element in the third RRC signaling.

12. The method according to claim 11, wherein the third RRC signaling is user equipment information response (UEInformationResponse) signaling, and the third information element is a flight path information report (FlightPathInfoReport) information element.

13. The method according to claim 10, further comprising:
on a condition that the total number of way points is greater than the maximum number of way points, receiving fourth RRC signaling sent by the base station, wherein the fourth RRC signaling instructs the unmanned aerial vehicle to continue to report flight path information; and
reporting, based on a second number of way points carried in the fourth RRC signaling, flight path information corresponding to the second number of way points to the base station through new third RRC signaling, wherein the second number of way points is a difference between the total number of way points and the maximum number of way points, and
wherein the second number of way points is carried in a fourth information element of the fourth RRC signaling, wherein the fourth RRC signaling is user equipment information request (UEInformationRequest) signaling, and the fourth information element is a flight path information report configuration (FlightPathInfoReportConfig) information element.

14-15. (canceled)

16. An information transmission method, performed by a base station, comprising:
receiving a total number of way points on a flight path of an unmanned aerial vehicle reported by the unmanned aerial vehicle.

17. The method according to claim 16, wherein receiving a the total number of way points on the flight path of the unmanned aerial vehicle reported by the unmanned aerial vehicle comprises:
receiving the total number of way points reported by the unmanned aerial vehicle through first radio resource control (RRC) signaling.

18. (canceled)

19. The method according to claim 17, wherein
the first RRC signaling is further used to report a notification message, and
the notification message notifies the base station that the unmanned aerial vehicle stores flight path information.

20-21. (canceled)

22. The method according to claim 16, further comprising:
sending second RRC signaling to the unmanned aerial vehicle, wherein the second RRC signaling configures a maximum number of way points for the unmanned aerial vehicle to report.

23. The method according to claim 22, wherein
the maximum number of way points is carried in a second information element of the second RRC signaling,
the second RRC signaling is user equipment information request (UEInformationRequest) signaling, and
the second information element is a flight path information report configuration (FlightPathInfoReportConfig) information element.

24. (canceled)

25. The method according to claim 22, further comprising:
receiving flight path information corresponding to a first number of way points reported by the unmanned aerial vehicle through third RRC signaling, wherein the first number of way points is a smaller one of the total number of way points and the maximum number of way points.

26-27. (canceled)

28. The method according to claim 25, further comprising:
on a condition that the total number of way points is greater than the maximum number of way points, sending fourth RRC signaling to the unmanned aerial vehicle, wherein the fourth RRC signaling instructs the unmanned aerial vehicle to continue to report flight path information; and
receiving flight path information corresponding to a second number of way points reported by the unmanned aerial vehicle through new third RRC signaling, wherein the second number of way points is a difference between the total number of way points and the maximum number of way points;
wherein the method further comprises:
setting a specified value in a fourth information element of the fourth RRC signaling as the second number of way points, wherein the fourth RRC signaling is user equipment information request (UEInformationRequest) signaling, and the fourth information element is a flight path information report configuration (FlightPathInfoReportConfig) information element.

29-34. (canceled)

35. An information configuration apparatus, comprising:
a processor; and
a memory, configured to store processor-executable instructions, and
wherein the processor is configured to: report, to a base station, a total number of way points on a flight path of an unmanned aerial vehicle.

36. An information configuration apparatus, comprising:
a processor; and
a memory, configured to store processor-executable instructions, and
wherein the processor is configured to execute the information transmission method according to claim 16.
